(19) United States
(12) Patent Application Publication
(10) Pub. No.: US 2019/0011402 A1
(43) Pub. Date: Jan. 10, 2019

(54) INSPECTION DEVICE, INSPECTION METHOD, AND NON-TRANSITORY RECODING MEDIUM STORING INSPECTION PROGRAM

(71) Applicant: NEC Corporation, Minato-ku, Tokyo (JP)

(72) Inventors: Shohei KINOSHITA, Tokyo (JP); Shigeru KASAI, Tokyo (JP)

(73) Assignee: NEC Corporation, Minato-ku, Tokyo (JP)

(21) Appl. No.: 16/073,420

(22) PCT Filed: Feb. 14, 2017
(86) PCT No.: PCT/JP2017/005223

§ 371 Date: Jul. 27, 2018

(30) Foreign Application Priority Data
Feb. 22, 2016 (JP) 2016-030696

(51) Int. Cl. G01N 29/12; G01N 29/48; G01H 13/00; G01N 3/06

(52) U.S. Cl. CPC G01N 29/12; G01N 29/48; G01N 2291/014; G01N 3/06; G01N 2291/015; G01H 13/00

(57) ABSTRACT

Provided are an inspection device and the like capable of correctly determining a state of an inspection target without destroying the inspection target. An inspection device calculates vibration characteristic values representing a character of vibration information indicating vibrations measured by vibration sensors measuring a vibration of an inspection target; calculates a scattering degree indicating a scattering degree of the calculated vibration characteristic values among the vibrations measured by the vibration sensors; and determines a condition of the inspection target based on a magnitude of the calculated scattering degree.

### TECHNICAL FIELD

The present invention relates to an inspection device and the like capable of inspecting a state of an inspection target without destroying the inspection target.

### BACKGROUND ART

An analysis of vibration characteristic of the inspection target is effective for determining damage of an inspection target (a measurement target) such as a material and a structure. The vibration character, for example, indicates a physical value (hereinafter, referred to as a “vibration characteristic value”) such as a damping ratio, a resonant frequency, which is calculated on the basis of a vibration. In other words, it is possible to determine the damage of the inspection target on the basis of the vibration characteristic value, such as the damping ratio and the resonant frequency, which are measured for the inspection target. For example, when damage such as a crack and deformation occurs in the inspection target, an elastic modulus of the inspection target decreases or energy dispersion for a vibration applied to (generated in) the inspection target increases. As a consequence, a damping ratio for the inspection target increases or a resonant frequency of the inspection target decreases.

Patent Literature 1 and Patent Literature 2 discloses examples of an inspection device that analyzes a vibration of the inspection target and inspects a state of the inspection target on the basis of the analyzed result.

Patent Literature 1 discloses an inspection device, which determines damage of a machine part coupling unit (an inspection target) based on tapping sound of the machine part coupling unit, as an example of an inspection device that inspects the presence or absence of damage based on a vibration. The inspection device hits the machine part coupling unit with a hammer. The blow (vibration force) is applied, so that the machine part coupling unit is excited by a unique free vibration thereto. The inspection device collects impact sound brought by the blow with a microphone installed at a single point, and analyzes the free vibration of the machine part coupling unit on the basis of the collected impact sound. That is, the inspection device calculates a vibration characteristic value, such as a frequency and a damping ratio related to the machine part coupling unit, on the basis of the collected impact sound. The inspection device determines damage state of the machine part coupling unit based on the calculated vibration characteristic value.

Patent Literature 2 discloses a vibration inspection device that evaluates a state of an inspection target by analyzing a vibration brought by a blow to the inspection target. The vibration inspection device receives the vibration brought by the blow to the inspection target and samples the received vibration. The vibration inspection device evaluates the state of the inspection target on the basis of a magnitude of a scattering degree of the sampled value.

### CITATION LIST

### Patent Literature

PTL 1: Japanese Utility Model Registration No. 3088577

PTL 2: Japanese Unexamined Patent Application Publication No. 2005-003508

### SUMMARY OF INVENTION

### Technical Problem

However, in the vibration characteristic value such as the damping ratio and the resonant frequency in the vibration of the inspection target, a large variation may be brought depending on the position of the damage of the inspection target or the type of the damage. For example, since the inspection devices disclosed in Patent Literature 1 and Patent Literature 2 determines the state of the inspection target based on the vibration collected by the microphone installed at the single point. When the vibration characteristic value has a variation, the inspection devices may not correctly determine the state of the inspection target.

Accordingly, an object of the present invention is to provide an inspection device and the like capable of correctly determining a state of an inspection target without destroying the inspection target.

### Advantageous Effects of Invention

### Solution to Problem

As an aspect of the present invention, an inspection device including:

characteristic value calculation means for calculating vibration characteristic values representing a character of vibration information indicating vibrations measured by vibration sensors measuring a vibration of an inspection target;

scattering degree calculation means for calculating a scattering degree indicating a scattering degree of the calculated vibration characteristic values among the vibrations measured by the vibration sensors; and

determination means for determining a condition of the inspection target based on a magnitude of the calculated scattering degree.

In addition, as another aspect of the present invention, an inspection method including:

calculating vibration characteristic values representing a character of vibration information indicating vibrations measured by vibration sensors measuring a vibration of an inspection target;

calculating a scattering degree indicating a scattering degree of the calculated vibration characteristic values among the vibrations measured by the vibration sensors; and

determining a condition of the inspection target based on a magnitude of the calculated scattering degree.

In addition, as another aspect of the present invention, an inspection program including:

a characteristic value calculation function for calculating vibration characteristic values representing a character of vibration information indicating vibrations measured by vibration sensors measuring a vibration of an inspection target;

a scattering degree calculation function for calculating a scattering degree indicating a scattering degree of the calculated vibration characteristic values among the vibrations measured by the vibration sensors; and

a determination function for determining a condition of the inspection target based on a magnitude of the calculated scattering degree.

Furthermore, the object is also realized by a computer-readable recording medium that records the inspection program.

### Advantageous Effects of Invention

The inspection device and the like according to the present invention can correctly determine a state of an inspection target without destroying the inspection target.

### BRIEF DESCRIPTION OF DRAWINGS

FIG. 1 is a block diagram illustrating a configuration of an inspection device according to a first example embodiment of the present invention.

FIG. 2 is a flowchart illustrating a processing flow in the inspection device according to the first example embodiment.

FIG. 3 is a block diagram illustrating a configuration of an inspection device according to a second example embodiment of the present invention.

FIG. 4 is a flowchart illustrating a processing flow in the inspection device according to the second example embodiment.

FIG. 5 is a diagram conceptually illustrating an example of a waveform including a free vibration.

FIG. 6 is a diagram conceptually illustrating an example of a waveform including a free vibration.

FIG. 7 is a diagram illustrating a damping ratio calculated based on vibration information measured around a center of a surface of a metal plate to be an inspection target.

FIG. 8 is a diagram illustrating a damping ratio calculated based on vibration information measured at 24 measuring points for a metal plate to be an inspection target.

FIG. 9 is a diagram illustrating a change of a scattering degree of a damping ratio versus a number of bending times.

FIG. 10 is a diagram illustrating a determination result for a damage degree of an inspection target based on vibration information measured at one measuring point (the single point) and a determination result for a state of the inspection target based on vibration information measured at 24 measuring points by an inspection device according to each example embodiment of the present invention.

FIG. 11 is a diagram illustrating a determination result of an inspection target state on the basis of vibration information measured at one measuring point and a determination result of the state of the inspection target 201 based on vibration information measured at 24 measuring points by the inspection device according to each example embodiment of the present invention.

FIG. 12 is a diagram illustrating an example of vibration modes used in a performance test and weights of each vibration mode in relation to a scattering degree.

FIG. 13 is a diagram illustrating a comparison between the number of correctly determined metal plates in damage determination for 30 metal plates based on vibration information measured at one measuring point and that the number determined by an inspection device according to each example embodiment of the present invention.

FIG. 14 is a diagram illustrating a determination result of an inspection target state on the basis of vibration information measured at one measuring point and a determination result of an inspection target state, with an inspection device according to each example embodiment of the present invention, on the basis of vibration information measured at 24 measuring points.

FIG. 15 is a block diagram schematically illustrating a hardware configuration of a calculation processing device capable of realizing inspection device according to each example embodiment of the present invention.

### EXAMPLE EMBODIMENT

Next, example embodiments of the present invention will be described in detail with reference to the drawings.

### First Example Embodiment

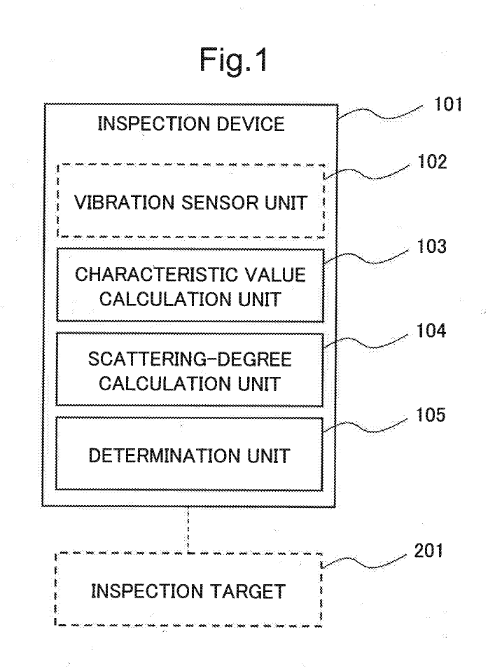

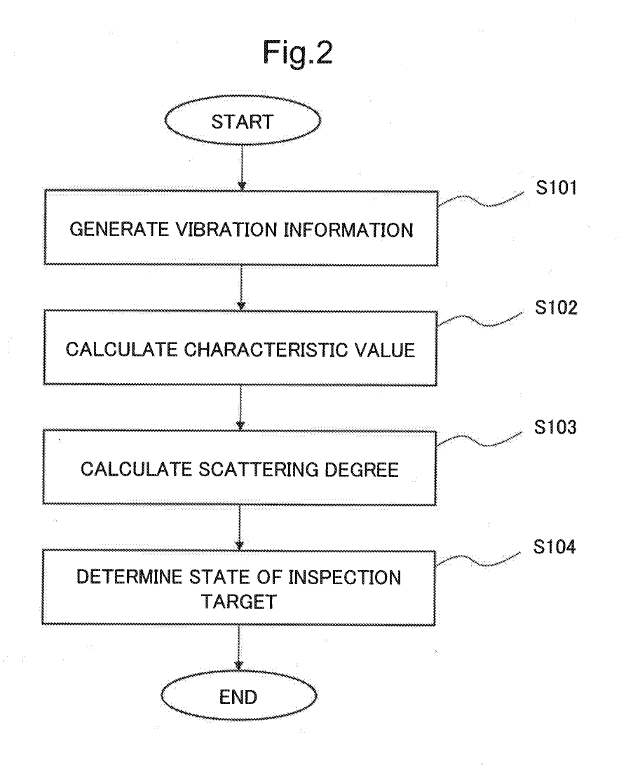

With reference to FIG. 1 and FIG. 2, a configuration of an inspection device 101 according to a first example embodiment of the present invention will be described in detail. FIG. 1 is a block diagram illustrating the configuration of the inspection device 101 according to the first example embodiment of the present invention. FIG. 2 is a flowchart illustrating a processing flow in the inspection device 101 according to the first example embodiment.

The inspection device 101 according to the first example embodiment includes a characteristic value calculation unit 103, a scattering degree calculation unit 104, and a determination unit 105. The inspection device 101 may further include a vibration sensor unit 102. Furthermore, the vibration sensor unit 102 may be connected to the inspection device 101 as a device that measures a vibration of an inspection target 201.

The vibration sensor unit 102 measures the vibration of the inspection target 201 at a plurality of different measuring points and generates vibration information indicating the vibration measured at each measuring point (step S101). The vibration sensor unit 102, for example, may be a vibration sensor installed at a plurality of measuring points on a surface of the inspection target 201 in accordance with a mechanical joining method and the like using an adhesive or a permanent magnet. Furthermore, the vibration sensor unit 102 may be a microphone that collects sound brought by the vibration of the inspection target 201 and is installed at a plurality of measuring points. That is, the vibration sensor unit 102 is not limited to the aforementioned example and it is sufficient if the vibration sensor unit 102 is a device that measures vibrations at different positions of the inspection target 201.

The characteristic value calculation unit 103 calculates a vibration characteristic value indicating a character of the vibration information on the basis of the vibration information generated by the vibration sensor unit 102 (step S102). The vibration characteristic value, for example, may be a damping ratio for a vibration mode (a vibration component) included in the vibration information and indicating a vibration aspect, or a resonant frequency (to be described later) related to the vibration mode.

The vibration mode, for example, indicates a vibration pattern such as a bending vibration, a torsional vibration, and a longitudinal vibration, and further indicates a vibration pattern unique to the inspection target 201. The bending vibration indicates a vibration mode of a bending direction (a pattern) of the inspection target 201. The torsional vibration indicates a vibration mode in a twisting direction (a pattern) of the inspection target 201. The longitudinal vibration indicates a vibration mode in a compressing and tensing direction (a pattern) of the inspection target 201.

In step S102, the vibration mode is not always one vibration mode, and may be plural as with a third example to be described later.

For each vibration information measured using vibration sensors and the like installed at a plurality of different measuring points, the characteristic value calculation unit 103 calculates a vibration characteristic value indicating the character of the vibration information in accordance with a predetermined characteristic value calculation procedure. The predetermined characteristic value calculation procedure, for example, is a procedure in which when the inspection target 201 is hit with an impulse hammer (that is, vibration force is applied to the inspection target 201), a vibration characteristic value of a vibration mode is calculated based on the applied blow and a vibration brought by the blow (also called “experimental modal analysis”). In the experimental modal analysis, when the inspection target 201 is hit (excited) with the impulse hammer and the like (input vibration is applied), the applied blow and a response vibration of the inspection target 201 due to the blow are measured by a vibration sensor and the like, and vibration information indicating the measured vibration is calculated. Since the experimental modal analysis of a vibration is a general method, detailed description of the experimental modal analysis will be omitted in the present example embodiment.

Next, in the experimental modal analysis, signal processing such as fast Fourier transform (FFT) is applied to the calculated two pieces of vibration information (the input vibration and the response vibration), so that the vibration mode of the inspection target 201 is specified. The vibration information for the applied input vibration, for example, is generated on the basis of a measurement result of the input vibration.

The characteristic value calculation unit 103 identifies the vibration mode included in the vibration information generated for the inspection target 201, and calculates a vibration characteristic value such as a damping ratio for the identified vibration mode and a resonant frequency for the identified vibration mode. The characteristic value calculation unit 103, for example, calculates the vibration characteristic value such as the damping ratio and the resonant frequency on the basis of a frequency response function indicating a relation between the input vibration and the response vibration. More specifically, the characteristic value calculation unit 103, for example, calculates the vibration characteristic value such as the damping ratio and the resonant frequency in accordance with a half-value width method. A first example to be described later illustrates an example in which the damping ratio is calculated as the vibration characteristic value. A second example to be described later illustrates an example in which the resonant frequency is calculated as the vibration characteristic value.

The characteristic value calculation unit 103 calculates a resonant frequency on the basis of a dominant frequency of frequencies included in the frequency response function. Furthermore, the characteristic value calculation unit 103 applies inverse Fourier transform to the frequency response function to calculate a waveform (that is, a “time waveform”) in a time domain, and applies a signal processing procedure such as a bandpass filter to the calculated time waveform. The characteristic value calculation unit 103 calculates a vibration characteristic value such as a damping ratio and a resonant frequency for the vibration information on the basis of the vibration information generated for the inspection target 201 through this processing. More specifically, the characteristic value calculation unit 103 calculates a logarithmic decrement for the calculated time waveform and calculates a damping ratio based on the calculated logarithmic decrement. Furthermore, the characteristic value calculation unit 103 calculates a period for the calculated time waveform and calculates a resonant frequency on the basis of the calculated period.

Moreover, the characteristic value calculation unit 103 calculates a vibration characteristic value indicating a character of a free vibration on the basis of the free vibration brought by the vibration force applied to the inspection target 201. The free vibration is a vibration unique to the inspection target 201, and for example, indicates a vibration operating at a natural frequency unique to the inspection target 201. The characteristic value calculation unit 103 calculates a vibration characteristic value of the inspection target 201 on the basis of vibration information indicating the measured free vibration, and determines the state (for example, whether or not damage has occurred or the degree of the damage) of the inspection target 201 according to the calculated vibration characteristic value.

The characteristic value calculation unit 103 performs the above-described calculation processing of the vibration characteristic value with respect to vibration information indicating vibrations measured at a plurality of measuring points spatially different from one another for the inspection target 201. Consequently, the vibration characteristic value calculated by the characteristic value calculation unit 103 indicates a character of the vibrations measured at the measuring points spatially distributed.

The scattering degree calculation unit 104 calculates a scattering degree (for example, a variance value), which indicates a scattering degree of the vibration characteristic value, with respect to the vibration characteristic value generated on the basis of the vibration information measured at the plurality of measuring points on an inspection target 201 (step S103). That is, the scattering degree calculation unit 104 calculates the scattering degree of the vibration characteristic value of the vibrations measured at the measuring points spatially distributed. The scattering degree is not always the variance value and may be an indicator such as an information entropy. The scattering degree is not limited to the aforementioned example.

The determination unit 105 determines the state (for example, whether or not damage has occurred or the degree of the damage) of the inspection target 201 on the basis of the scattering degree calculated by the scattering degree calculation unit 104 (step S104). The damage is crack, plastic deformation or the like. The plastic deformation, for example, indicates permanent deformation or residual deflection of the inspection target 201. The determination unit 105, for example, compares the calculated scattering degree with a scattering degree (hereinafter, referred to as a “scattering degree under suffering damage”) calculated for a damaged inspection target 201 or a scattering degree (hereinafter, referred to as a “scattering degree under not suffering damage”) calculated for an undamaged inspection target 201. When the scattering degree calculated for the inspection target 201 is near the scattering degree under suffering damage, the determination unit 105 determines that the inspection target 201 suffers damage (or the damage is serious). When the scattering degree calculated for the inspection target 201 is near the scattering degree under not suffering damage, the determination unit 105 determines that the inspection target 201 suffers no damage (or the damage is light).

When determining the state of the inspection target 201, the determination unit 105 may calculate a difference between a scattering degree calculated on the basis of vibration information measured at a first timing and a scattering degree calculated on the basis of vibration information measured at a second timing. For example, the determination unit 105 may calculate the damage degree due to an aged change of the inspection target 201 on the basis of a ratio of the calculated difference and a difference between the scattering degree under suffering damage and the scattering degree under not suffering damage.

Next, advantageous effects of the inspection device 101 according to the first example embodiment will be described.

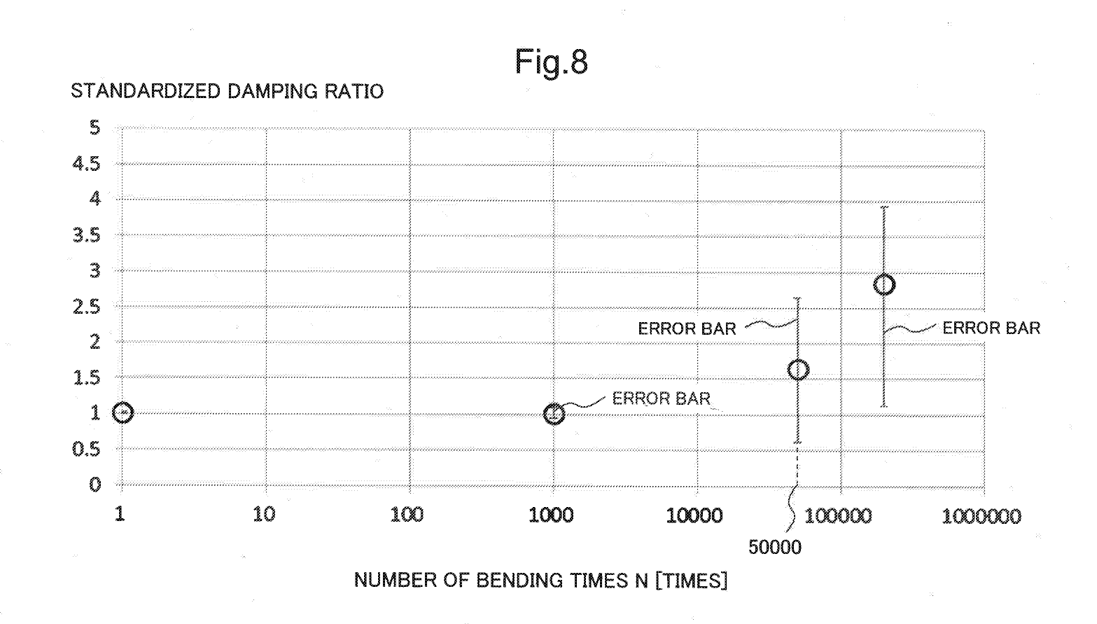

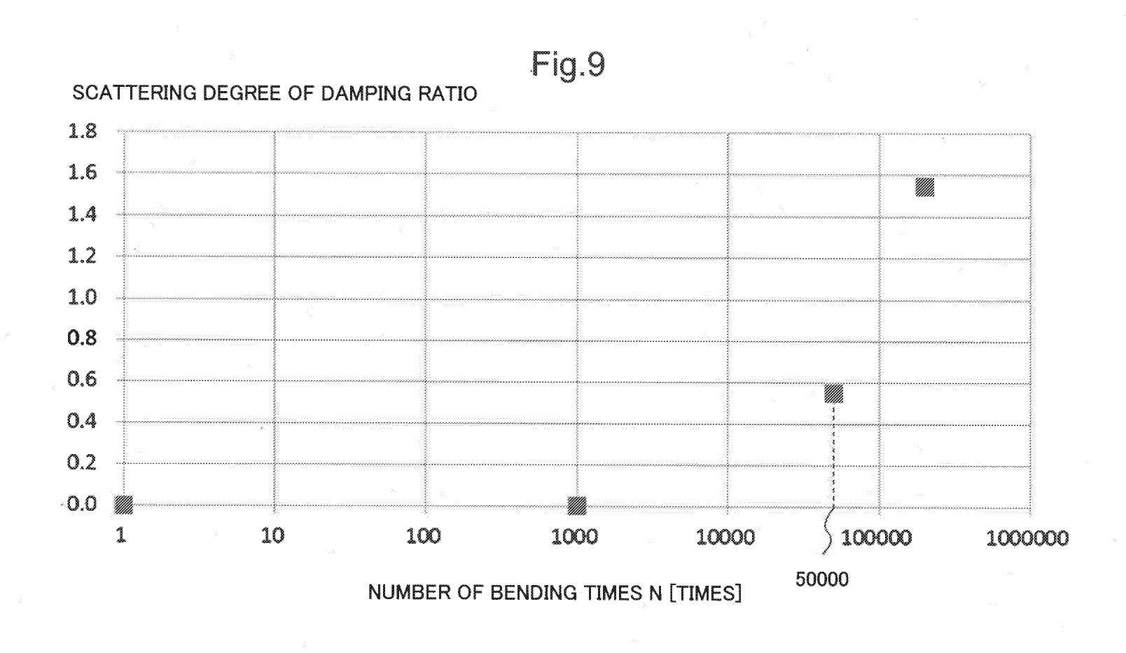

The inspection device 101 according to the present example embodiment can correctly determine the state of the inspection target. The reason for this is because scattering degrees of vibration characteristic values of vibrations measured at a plurality of different measuring points differ depending on the degree (the position and the type) of damage of the inspection target 201 such as a material and a structure and the inspection device 101 according to the present example embodiment determines the state of the inspection target 201 on the basis of the scattering degrees. The reason will be described in detail later with reference to FIG. 8 and FIG. 9. In brief, the present inventor measured vibrations of the inspection target 201 by, for example, vibration sensors and the like disposed at a plurality of different measuring points and found regularity between scattering degrees among the measured vibrations and the state of the inspection target 201. Further, the present inventor found regularity that as the scattering degree is larger, the damage degree of the inspection target 201 is more serious, and as the scattering degree is smaller, the damage degree of the inspection target 201 is lighter. Consequently, the inspection device 101 determines the state (for example, whether or not damage has occurred or the degree of the damage) of the inspection target 201 on the basis of the regularity found by the present inventor, so that it is possible to correctly determine the state of the inspection target.

### Second Example Embodiment

Next, a second example embodiment of the present invention based on the aforementioned first example embodiment will be described.

In the following description, characteristic parts according to the present example embodiment will be mainly described, and the same reference numerals are used to designate the same elements as those of the aforementioned first example embodiment in order to omit redundant description.

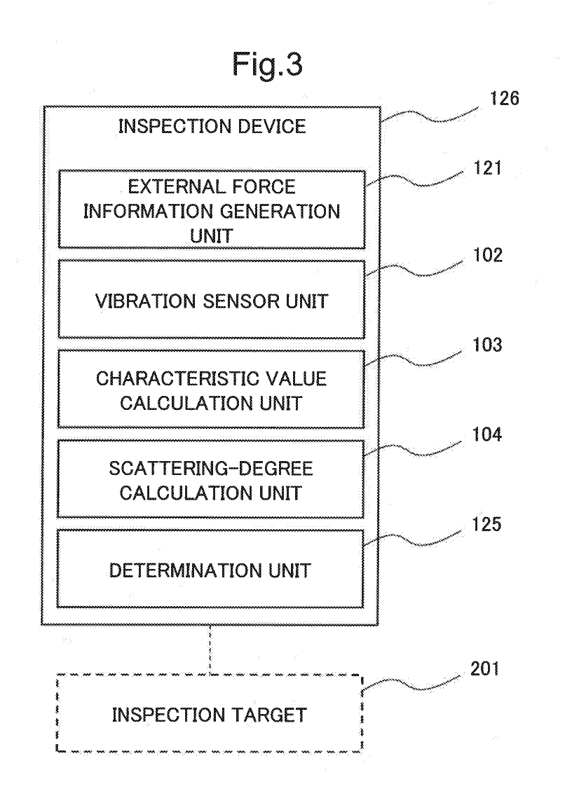

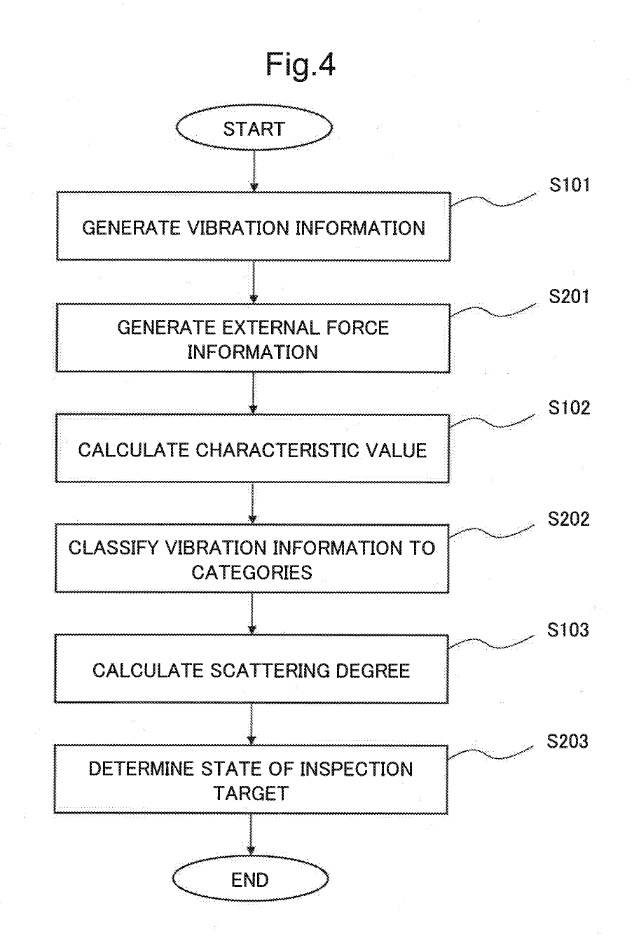

With reference to FIG. 3 and FIG. 4, a configuration of an inspection device 126 according to the second example embodiment of the present invention will be described in detail. FIG. 3 is a block diagram illustrating the configuration of the inspection device 126 according to the second example embodiment of the present invention. FIG. 4 is a flowchart illustrating a processing flow in the inspection device 126 according to the second example embodiment.

The inspection device 126 according to the second example embodiment includes an external force information generation unit 121, a vibration sensor unit 102, a characteristic value calculation unit 103, a scattering degree calculation unit 104, and a determination unit 125.

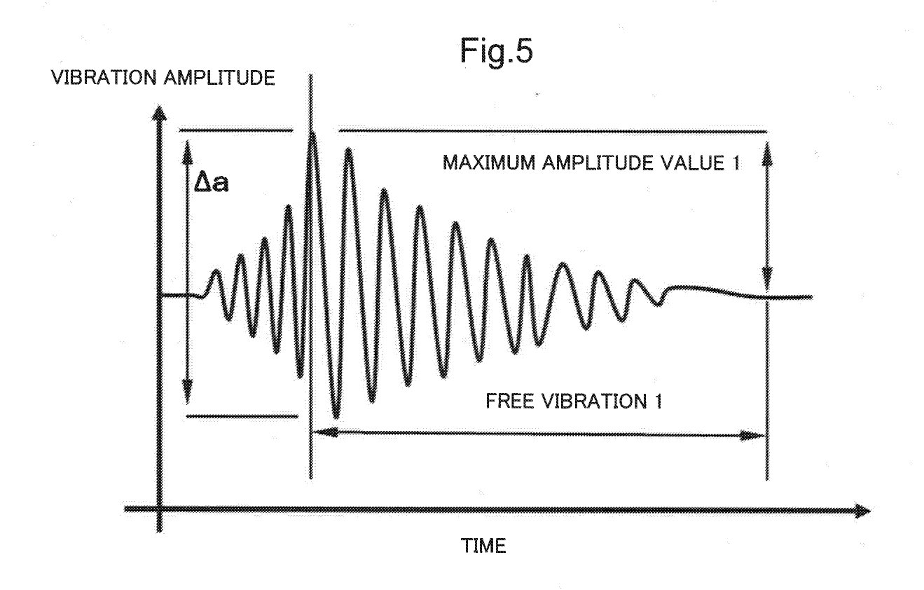

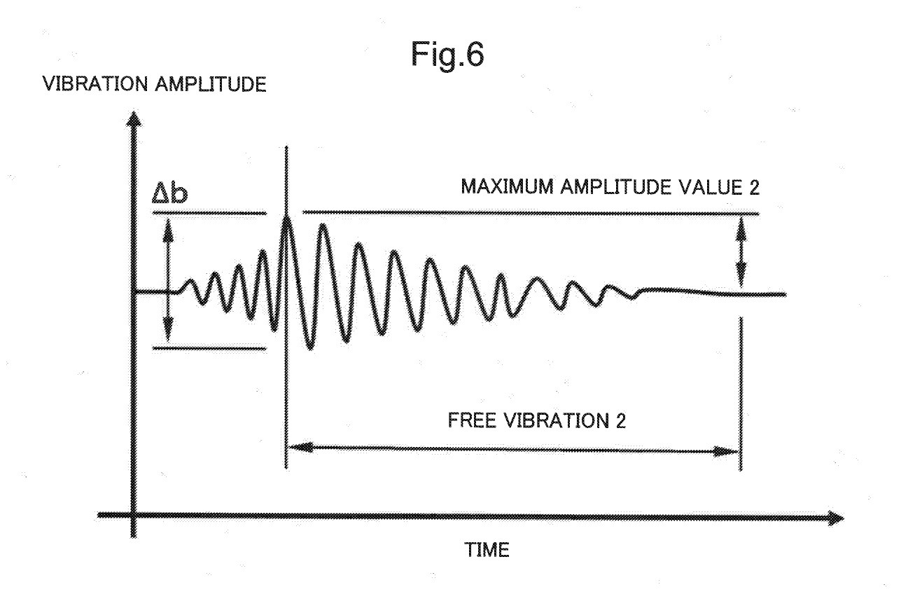

The vibration sensor unit 102 measures vibrations of the inspection target 201 at a plurality of different measuring points and generates vibration information indicating the vibration measured at each measuring point (step S101). The vibration information, for example, represents a time history waveform indicating a change in an amplitude of the vibration versus the time transition as illustrated in FIG. 5 or FIG. 6.

The external force information generation unit 121 generates information (for convenience of explanation, indicating “external force information” to be described later with reference to FIG. 5 or FIG. 6) indicating values related to strength of external force applied to the inspection target 201 on the basis of the generated vibration information (step S201).

The characteristic value calculation unit 103 calculates a vibration characteristic value indicating a character of the vibration information in accordance with a similar procedure to that illustrated in the first example embodiment, on the basis of the vibration information generated by the vibration sensor unit 102 (step S102). The execution order of step S102 and step S201 is arbitrary.

The determination unit 125 classifies vibration information for a measured free vibration to a plurality of categories based on values of the generated external force information (step S202). The categories, for example, indicate ranges of values of external force information (to be described later with reference to FIG. 5 or FIG. 6). In this case, the plurality of categories indicate different value ranges of the external force information, respectively. In other words, a certain category includes vibration information representing that the values of the external force information are in a certain range. Next, the determination unit 125 calculates a scattering degree of the vibration characteristic value, which is generated for the vibration information in step S102, for each category (step S103).

The determination unit 125 determines the state (for example, whether or not damage has occurred or the degree of the damage) of the inspection target 201 for each category in accordance with a similar procedure to step S104 illustrated in the first example embodiment, on the basis of the scattering degree calculated for each category (step S203). For example, the determination unit 125 determines the state (for example, whether or not damage has occurred or the degree of the damage) of the inspection target 201 on the basis of a scattering degree under suffering damage calculated for each category and a scattering degree under not suffering damage calculated for each category. The determination unit 125, for example, selects a category corresponding to the values of the calculated external force information, and determines the state of the inspection target 201 on the basis of a result of comparing the calculated scattering degree with a scattering degree under suffering damage in the selected category and a scattering degree under not suffering damage in the selected category.

The following fourth example illustrates an example in which the vibration information is classified to a plurality of categories.

Next, with reference to FIG. 5 and FIG. 6, the external force information will be described. FIG. 5 and FIG. 6 are diagrams conceptually illustrating an example of a waveform including a free vibration. The external force information, for example, indicates a maximum amplitude value (or a substantially maximum amplitude value) of a free vibration brought by external force in a waveform indicating an amplitude value versus time transition. Hereinafter, for convenience of explanation, it is assumed that “maximum” includes both maximum and substantially maximum.

Strength of applied external force when a waveform exemplified in FIG. 5 is measured takes a different value in comparison with strength of applied external force when a waveform exemplified in FIG. 6 is measured. When the external force differs in strength, maximum amplitude values differ in waveforms of a free vibration depending on the strength of the external force. For example, a maximum amplitude value “1” in the free vibration illustrated in FIG. 5 is larger than a maximum amplitude value “2” in the free vibration illustrated in FIG. 6. The strength of the applied external force so as to generate free vibration in the case of the free vibration “1” exemplified in FIG. 5 is larger than that in the case of the free vibration “2” exemplified in FIG. 6. Consequently, the maximum amplitude value is an example of the external force information because it is related to the strength of the external force.

The external force information may be a difference between the maximum amplitude value of the free vibration and a variation value (a minimum amplitude value or an approximate minimum amplitude value) in an opposite direction of the maximum amplitude value of the free vibration. In the free vibration “1” illustrated in FIG. 5, the difference (that is, the external force information) is Δa. In the free vibration “2” illustrated in FIG. 6, the difference (that is, the external force information) is Δb. Even in this case, when the case of the free vibration “1” illustrated in FIG. 5 is compared with the case of the free vibration “2” illustrated in FIG. 6, the difference in the free vibration 1 illustrated in FIG. 5 is larger than that in the free vibration “2” illustrated in FIG. 6. Consequently, the difference is an example of the external force information because it is related to the strength of the external force.

Next, advantageous effects of the inspection device 126 according to the second example embodiment will be described.

The inspection device 126 according to the present example embodiment can correctly determine the state of the inspection target 201. The reason for this is similar to that described in the first example embodiment.

Moreover, the inspection device 126 according to the present example embodiment obtains an advantageous effect that it is possible to more correctly determine the state (for example, whether or not damage has occurred or the degree of the damage) of the inspection target 201 even though the strength of the external force is scattered. The reason for this is because the inspection device 126 classifies a free vibration brought by external force to categories indicating the strength of the same (or similar) external force on the basis of the external force information and calculates a scattering degree for each category. Consequently, for example, even though the strength of the external force is scattered, the inspection device 126 according to the present example embodiment obtains the advantageous effect that it is possible to more correctly determine the state (for example, whether or not damage has occurred or the degree of the damage) of the inspection target 201.

Moreover, the inspection device 126 according to the present example embodiment obtains an advantageous effect that a device for measuring strength of external force is not required because vibration information of free vibration is classified to a plurality of categories on the basis of a maximum amplitude value or the like of the free vibration related to the strength of the external force instead of external force applied to the inspection target 201. In other words, the inspection device 126 according to the present example embodiment obtains an advantageous effect that the inspection device 126 is lightweight.

Next, with reference to examples illustrated in the first example to the fourth example, processing of the inspection device 126 according to the present example embodiment and advantageous effects obtained by the inspection device 126 will be described.

### First Example

The following description will be provided for an example of the inspection device 126 that determines the state (for example, whether or not damage has occurred or the degree of the damage) of a metal plate to be the inspection target 201 when a bending fatigue test is applied to the metal plate. In the bending fatigue test, when the metal plate is intermittently bent and extended, a load (hereinafter, referred to as a “fatigue load”) causing physical fatigue is intermittently applied to the metal plate from an exterior. As the fatigue load is intermittently applied to the metal plate from an exterior, metal plate damage worsens. In other words, in the bending fatigue test, as the number of bending times increases, the damage worsens.

In the first example, the size of the metal plate is 50 mm (millimeter) in a width direction, is 100 mm in a longitudinal direction, and is 0.1 mm in a thickness direction. The number of metal plates is 30. The inspection device 126 determines the state (for example, whether or not damage has occurred or the degree of the damage) of each metal plate to be the inspection target 201.

In the inspection device 126, the vibration sensor unit 102 generates vibration information at a plurality of different measuring points every predetermined number of bending times in relation to each metal plate subjected to the bending fatigue test.

The characteristic value calculation unit 103 calculates a damping ratio as a vibration characteristic value indicating a character of vibration information in accordance with the experimental modal analysis. The characteristic value calculation unit 103 calculates a scattering degree of the damping ratio in relation to the vibration information measured at each measuring point. A procedure for calculating the damping ratio will be described in detail.

In the bending fatigue test, impact force (external force or vibration force) is applied to the metal plate with an impulse hammer after bending and extending the metal plate by a predetermined number of bending times.

The inspection device 126 has the vibration sensor unit 102 including vibration sensors installed at 24 different measuring points on the surface of the metal plate. Each vibration sensor measures a vibration (a response vibration), which is brought by the impact force applied with the impulse hammer, at respective measuring points at which the vibration sensor is installed, and generates vibration information indicating the measured vibrations.

The characteristic value calculation unit 103 calculates a transfer function (a frequency response function) indicating a relationship between the applied impact force and the generated vibration information, and, thereby, calculates a damping ratio indicating the damping degree of vibration in the transfer function. The characteristic value calculation unit 103, for example, calculates a transfer function for a vibration characteristic value indicating a bending primary mode, and, thereby, calculates a damping ratio included in the transfer function. In more detail, the characteristic value calculation unit 103 calculates damping ratios for the vibration information generated by the vibration sensors at 24 measuring points, and calculates scattering degrees of the damping ratios for the vibration information measured at the measuring points.

Hereinafter, a relation between the vibration characteristic value and the state of the inspection target 201 will be described. When the inspection target 201 is being damaged, an elastic modulus of the inspection target 201 reduces due to occurrence or progress of crack or a plastic region in the inspection target 201, and results in an increase of an energy dissipation amount of the inspection target 201. As a consequence, when the damage of the inspection target 201 progresses, the vibration characteristic value, for example, monotonously increases (or monotonously decreases). For example, when the damage of the inspection target 201 progresses, the damping ratio monotonously increases.

Next, a performance test performed in this example and results of the performance test will be described.

The first example shows a comparison result of performances based on the number of correctly determined meatal plates among 30 metal plates. One performance is determined on the basis of vibration information measured at one measuring point (a single point). The other performance is determined on the basis of vibration information measured using the inspection device 126 (at a plurality of measuring points). In the first example, it is assumed that determination for a metal plate state is correct when a vibration characteristic value monotonously increases or monotonously decreases versus damage progression due to an increase of the number of bending times.

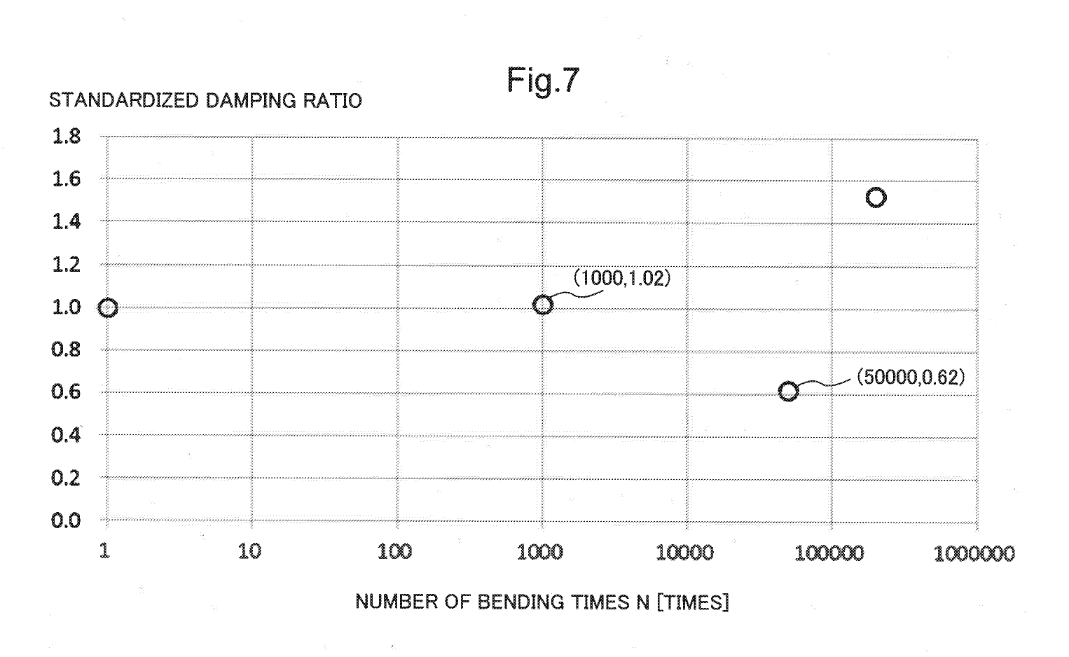

The first performance test is for determining the damage degree of a metal plate based on vibration information measured at one measuring point (a single point) in relation to the metal plate. The result of the first performance test is illustrated in FIG. 7. FIG. 7 is a diagram illustrating a damping ratio calculated based on vibration information measured around the center of the surface of the metal plate to be the inspection target 201. In FIG. 7, a horizontal axis denotes the number of bending times of metal plate and denotes that the number of bending times increases (that is, damage worsens) toward the right side. In FIG. 7, a vertical axis denotes a damping ratio calculated after the metal plate is bent by the number of bending times and denotes that the damping ratio increases toward the upper side. The damping ratio indicates a value (hereinafter, referred to as a “standardized damping ratio”) standardized on the basis of a damping ratio calculated on the basis of vibration information measured when the number of bending times is 0.

Referring to FIG. 7, even when the number of bending times increases, the damping ratio changes irregularly. For example, when the number of bending times is 1,000, the standardized damping ratio is 1.02. When the number of bending times is 50,000, the standardized damping ratio is 0.62. Consequently, even when the number of bending times increases, since the damping ratio does not always monotonously decrease, the damping ratio is a parameter having a value greatly changed in accordance with a slight change in the vibration information. As a consequence, when it is determined whether or not the inspection target 201 has suffered damage based on the damping ratio calculated on the basis of the vibration information measured by a vibration sensor installed at the single point, the determination result may be erroneous.

FIG. 8 represents a calculated damping ratio based on vibration information measured at a plurality of measuring points such as the inspection device 126 according to the present example embodiment. FIG. 8 is a diagram illustrating a damping ratio calculated based on vibration information measured at 24 measuring points for a metal plate to be the inspection target 201. In FIG. 8, a horizontal axis denotes the number of bending times of the metal plate and denotes that the number of bending times increases (that is, damage worsens) toward the right side. In FIG. 8, a vertical axis denotes a damping ratio calculated after bending metal plate by the number of bending times and denotes that the damping ratio increases toward the upper side. The damping ratio indicates a value standardized on the basis of a damping ratio calculated on the basis of vibration information measured at a point around the center of the surface of the metal plate when the number of bending times is 0. In FIG. 8, in the direction of the standardized damping ratio, maximum values and minimum values of the damping ratio calculated on the basis of the vibration information measured at 24 measuring points are illustrated by error bars (in FIG. 8, vertically long solid lines illustrated around and the like the number (50,000) of bending times).

Referring to FIG. 8, particularly, when the number of bending times is 50,000 or more, vertically long error bars appear as compared with a case where the number of bending times is 1,000 and the like. This indicates that the damping ratio for the vibration information measured at 24 measuring points has variety. Furthermore, in FIG. 8, as the number of bending times increases, a range of the error bar becomes large. This indicates that a spatial scattering degree for the damping ratio increases as metal plate damage worsens. The reason for the scattering-degree increase of the damping ratio depending on the number of bending times is estimated as that a change of an indicator for a metal plate, such as an elastic modulus and an energy dissipation amount, becomes large depending on measuring points when damage such as crack occurs and worsens in the metal plate.

The scattering degree of the damping ratio illustrated in FIG. 8 is illustrated in FIG. 9. FIG. 9 is a diagram illustrating a change of the scattering degree of the damping ratio versus the number of bending times. In FIG. 9, a horizontal axis denotes the number of bending times of metal plate and denotes that the number of bending times increases (that is, damage worsens) toward the right side. In FIG. 9, a vertical axis denotes the scattering degree of the damping ratio calculated after bending the metal plate by the number of bending times and denotes that the scattering degree increases toward the upper side.

Referring to FIG. 9, as the number of bending times increases, the scattering degree of the damping ratio increases rapidly. This indicates that the scattering degree of the damping ratio calculated for the metal plate increases rapidly as metal plate damage worsens.

The inspection device 126 according to the present example embodiment determines the state (for example, whether or not damage has occurred or the degree of the damage) of the inspection target 201 on the basis of the above-described regularity that the scattering degree becomes larger as damage of the inspection target 201 worsens.

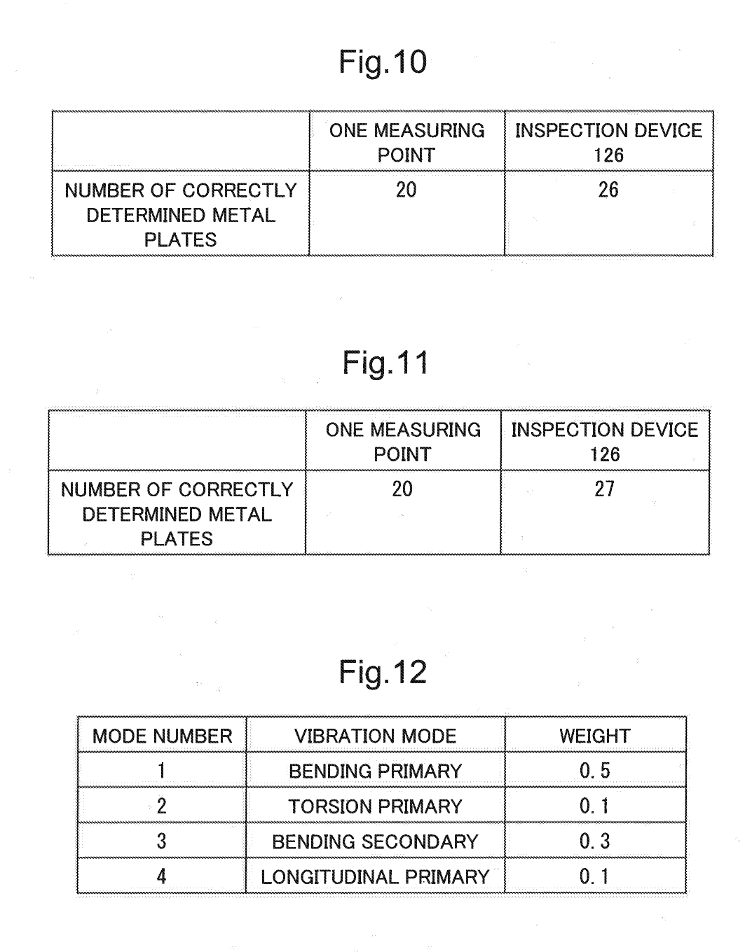

With reference to FIG. 10, an example of advantageous effects of the inspection device 126 according to the present example embodiment will be described. FIG. 10 is a diagram illustrating a determination result for the damage degree of the inspection target 201 on the basis of the vibration information measured at one measuring point (the single point) and a determination result for the state of the inspection target 201 on the basis of the vibration information measured at 24 measuring points by the inspection device according to each example embodiment of the present invention.

The determination result for the damage degree of the inspection target 201 on the basis of the vibration information measured at one measuring point, for example, indicates the result determined by the inspection device disclosed in Patent Literature 1 and the like. The determination result for the damage degree of the inspection target 201 on the basis of the vibration information measured at 24 measuring points indicates the result determined by the inspection device 126 according to the present example embodiment.

Referring to FIG. 10, the number of correctly determined metal plates is 20 when the vibration information is measured at one measuring point. The number of correctly determined metal plates is 26 when the vibration information (the inspection device 126 according to the present example embodiment) is measured at 24 measuring points. Consequently, the inspection device 126 according to the present example embodiment enables correct determination of the state (for example, whether or not damage has occurred or the degree of the damage) of the inspection target 201. The reason for this is because, when a vibration characteristic value such as a damping ratio is easily changed due to the positions of measuring points for measuring vibration information of the inspection target 201 and thus the state of the inspection target 201 is determined based on the vibration characteristic value, the determination result is affected by a change in the vibration characteristic value. As the inspection device 126 according to the present example embodiment determines the state of the inspection target 201 on the basis of the regularity that the scattering degree of the vibration characteristic value becomes larger as damage of the inspection target 201 worsens, the vibration characteristic value is less likely to be affected by a change of the measuring point.

### Second Example

Next, the following description will be provided for an example in which the inspection device 126 determines the state (for example, whether or not damage has occurred or the degree of the damage) of the inspection target 201 on the basis of a resonant frequency of the inspection target 201.

In the inspection device 126, the vibration sensor unit 102 generates vibration information at a plurality of different measuring points every predetermined number of bending times for each metal plate subjected to the bending fatigue test.

The characteristic value calculation unit 103 calculates a resonant frequency as a vibration characteristic value indicating a character of the vibration information in accordance with the experimental modal analysis, and further calculates scattering degrees at the plurality of different measuring points with respect to the calculated resonant frequency.

A performance test is for determining a damage degree of a metal plate on the basis of vibration information measured at one measuring point (a single point) on the metal plate. In the performance test, a resonant frequency is calculated on the basis of the vibration information measured at one measuring point (the single point), and the damage degree of the metal plate is determined on the basis of the calculated resonant frequency. In contrast, the inspection device 126 according to the present example embodiment calculates a resonant frequency on the basis of vibration information measured at each of 24 measuring points, calculates scattering degrees at the measuring points with respect to the calculated resonant frequency, and determines the damage degree of the inspection target 201 on the basis of the calculated scattering degrees. FIG. 11 represents these results. FIG. 11 is a diagram illustrating a determination result of the inspection target state on the basis of the vibration information measured at one measuring point and a determination result of the state of the inspection target 201 on the basis of the vibration information measured at 24 measuring points by the inspection device according to each example embodiment of the present invention.

Referring to FIG. 11, the number of correctly determined metal plates is 20 when the vibration information is measured at one measuring point. The number of correctly determined metal plates is 27 when the vibration information is measured (that is, using the inspection device 126) at 24 measuring points. Consequently, the inspection device 126 according to the present example embodiment enables correct determination of the state (for example, whether or not damage has occurred or the degree of the damage) of the inspection target 201. The reason for this is because a reason similar to the reason described in relation to the damping ratio is also common to the resonant frequency.

### Third Example

In the third example, the inspection device 126 calculates scattering degrees of damping ratios for each vibration mode included in the measured vibration information, and determines the state (for example, whether or not damage has occurred or the degree of the damage) of the inspection target 201 (a metal plate) on the basis of a weighted average of the calculated scattering degrees.

In the bending fatigue test of the metal plate as illustrated in the first example, the inspection device 126 calculates vibration modes included in the vibration information, in accordance with the experimental modal analysis, regarding to vibration information measured after bending and extending the metal plate by a predetermined number of bending times. The inspection device 126 calculates a damping ratio as a vibration characteristic value for each of the calculated vibration modes. Next, the inspection device 126 calculates a scattering degree of the damping ratio for each vibration mode in relation to vibration information measured at a plurality of measuring points. In relation to each vibration mode, the inspection device 126 multiplies the scattering degree calculated for the vibration mode by a weight related to the vibration mode, and, thereby, calculates the total sum (that is, a weighted average) of the calculated values. Hereinafter, the calculated total sum will be referred to as a “weighted sum value”. The inspection device 126 determines the state (for example, whether or not damage has occurred or the degree of the damage) of the inspection target 201 (the metal plate) on the basis of the calculated weighted sum value.

In other words, the determination unit 125 determines the state (for example, whether or not damage has occurred or the degree of the damage) of the inspection target 201 in each of a plurality of vibration modes on the basis of values of the weighted scattering degree calculated for the vibration characteristic value in accordance with predetermined weighting. The determination unit 125, for example, calculates the scattering degree of the damping ratio in each of a plurality of vibration modes, calculates the sum value (that is, a weighted average of the scattering degrees) of the weighted scattering degree in each vibration mode, and determines whether or not the inspection target 201 has suffered damage on the basis of the calculated sum value. Weights applied to the scattering degree may differ depending on the inspection target 201.

With reference to FIG. 12, weights of scattering degree will be described. FIG. 12 is a diagram illustrating an example of vibration modes used in the performance test and weights of each vibration mode in relation to the scattering degree. In the third example, as illustrated in FIG. 12, predetermined weights are given for four different vibration modes among the vibration modes included in the vibration information. In the predetermined weights, a weight of a vibration mode mainly related to a target event is set to have a value larger than a weight of the other vibration modes. When each vibration mode is equivalently related to the event, weights of each vibration mode are set as the same value.

For example, in FIG. 12, mode number “2”, vibration mode “torsion primary”, and weight “0.1” are associated with one another. This indicates that a scattering degree of the vibration mode “torsion primary” identified by the mode number “2” is weighted based on the weight “0.1”. Furthermore, for example, in FIG. 12, mode number “3”, vibration mode “torsion secondary”, and weight “0.3” are associated with one another. This indicates that a scattering degree of the vibration mode “bending secondary” identified by the mode number “3” is weighted according to the weight “0.3”. As with the example, when a target event is bending fatigue of a metal plate, a vibration mode mainly related to the event, for example, is the vibration mode “bending primary”. In this case, as illustrated in FIG. 12, the weight of the vibration mode “bending primary” is set to have a value larger than weights of the other vibration modes in the predetermined weights.

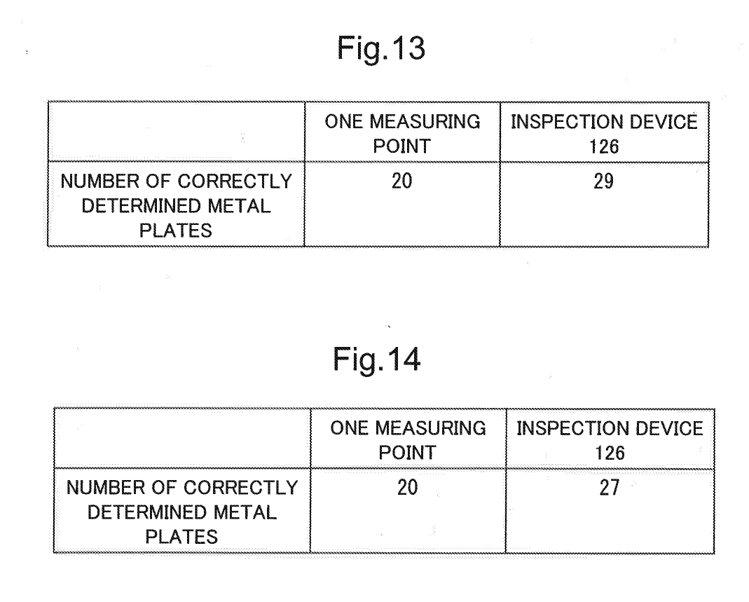

The performance test is for determining damage progression due to the fatigue of the metal plate on the basis of the damping ratio for the vibration information measured at one measuring point (a center of a metal plate). FIG. 13 shows results of the performance test. FIG. 13 is a diagram illustrating a comparison between the number of correctly determined metal plates in damage determination for 30 metal plates on the basis of the vibration information measured at one measuring point and that the number determined by the inspection device 126 according to the present example embodiment.

Referring to FIG. 13, the number of correctly determined metal plates is 20 when the determination is based on the vibration information measured at one measuring point. The number of correctly determined metal plates is 29 when the inspection device according to each example embodiment of the present invention executes the determination processing. Consequently, the inspection device 126 according to the present example embodiment enables correct determination of the state (for example, whether or not damage has occurred or the degree of the damage) of the metal plate as compared with the case where the state of the metal plate is determined on the basis of the vibration information measured at one measuring point.

Furthermore, when the value (26 in the column “inspection device 126”) illustrated in FIG. 10 and the value (29 in the column “inspection device 126”) illustrated in FIG. 13 are compared with each other, the number of correctly determined metal plates is large in the latter case. Consequently, as illustrated in the third example, indicator of weighted scattering degree in each vibration mode can achieve higher determination accuracy than non-weighted indicator.

### Fourth Example

In the fourth example, the inspection device 126 calculates a damping ratio as a vibration characteristic value on the basis of a free vibration (a response vibration for external force (vibration force)) brought when the external force is applied to the inspection target 201.

In the bending fatigue test of the metal plate as illustrated in the first example, the inspection device 126 measures free vibrations, which are brought when vibration force is applied to the metal plate with an impulse hammer, at a plurality of different measuring points every predetermined number of bending times, and generates vibration information indicating the measured free vibrations. The inspection device 126 calculates a damping ratio for the generated vibration information at each of the measuring points, and calculates a scattering degree for the calculated damping ratio. In other words, in the fourth example, the inspection device 126 calculates the damping ratio on the basis of only the measured free vibrations without referring to external force information.

In the fourth example, the strength of the vibration force applied with the impulse hammer is scattered. As a consequence, the amplitude of vibration force differs depending on the strength of the vibration force in relation to the free vibrations brought by the vibration force.

In addition to the aforementioned processes, the inspection device 126 further calculates a maximum value of the amplitude as external force information at each measuring point in time history waveforms indicating the free vibrations. The inspection device 126 classifies the measured free vibrations to three categories based on the maximum value calculated at each measuring point. The inspection device 126 calculates scattering degrees of damping ratios relating to free vibrations classified to the same category by each number of bending times, and determines the state (for example, whether or not damage has occurred or the degree of the damage) of the inspection target 201 on the basis of the calculated scattering degrees.

With reference to FIG. 14, the determination result of the fourth example will be described. FIG. 14 is a diagram illustrating a determination result of an inspection target state on the basis of vibration information measured at one measuring point and a determination result of the inspection target 201 state, with the inspection device according to each example embodiment of the present invention, on the basis of vibration information measured at 24 measuring points.

In the fourth example, when damage of metal plates is determined on the basis of the vibration information measured at one measuring point, damage of 20 metal plates is correctly determined among 30 metal plates. In contrast, damage of 27 metal plates is correctly determined among 30 metal plates in accordance with the inspection device 126 according to the present example embodiment. This result is similar to that illustrated in FIG. 11. Consequently, since the number of correctly determined metal plates by the inspection device 126 according to the present example embodiment is larger than the number of metal plates determined on the basis of the vibration information measured at one measuring point, it is possible to correctly determine the state (for example, whether or not damage has occurred or the degree of the damage) of the inspection device 126 in accordance with the inspection device 126 according to the present example embodiment.

Moreover, the inspection device 126 does not measure the strength of the vibration force and generates external force information on the basis of the maximum amplitude value in the measured free vibration. Consequently, in accordance with the inspection device 126 according to the present example embodiment, an element for measuring the strength of the vibration force is not required, so that it is possible to simplify the inspection device 126 itself.

The inspection device 126 may not include a measurement unit (not illustrated) for measuring the strength of the vibration force. Also in this case, in accordance with the inspection device 126 according to the present example embodiment, it is possible to correctly determine the state (for example, whether or not damage has occurred or the degree of the damage) of the inspection device 126.

### Hardware Configuration Example

A configuration example of hardware resources that realize an inspection device according to each example embodiment of the present invention will be described. However, the inspection device may be realized using physically or functionally at least two calculation processing devices. Further, the inspection device may be realized as a dedicated device.

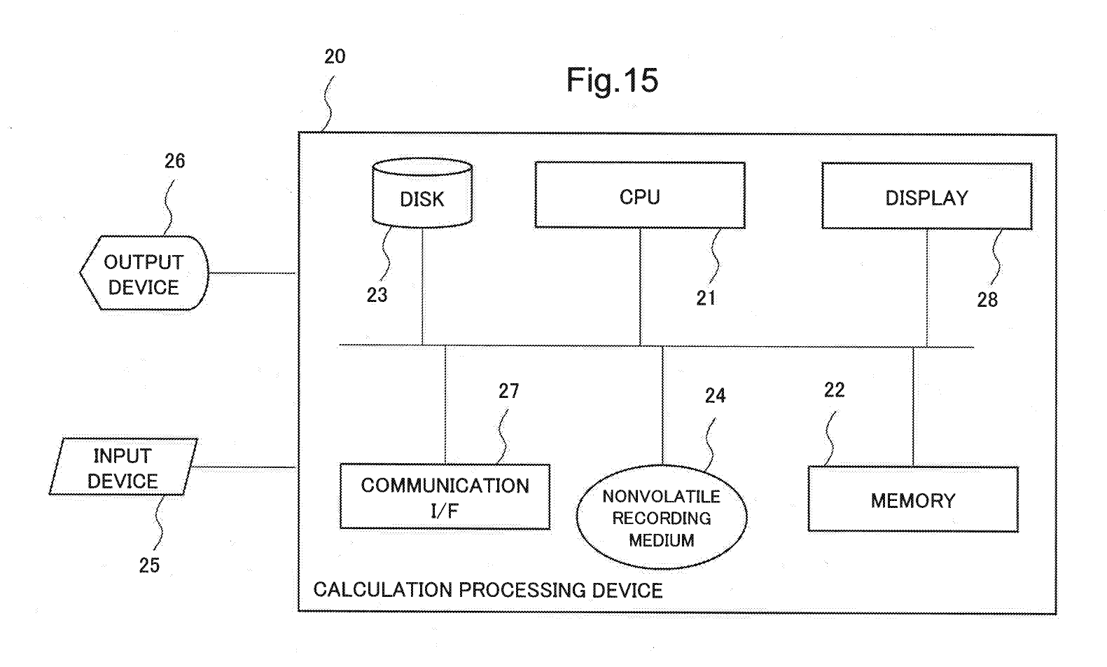

FIG. 15 is a block diagram schematically illustrating a hardware configuration of a calculation processing device capable of realizing inspection device according to the first and second example embodiments of the present invention. A calculation processing device 20 includes a central processing unit (CPU) 21, a memory 22, a disk 23, a non-transitory recording medium 24, a communication interface (hereinafter, expressed as. “communication I/F”) 27, and a display 28. The calculation processing device 20 may connect an input device 25 and an output device 26. The calculation processing device 20 can execute transmission/reception of information to/from another calculation processing device and a communication device via the communication I/F 27.

The non-transitory recording medium 24 is, for example, a computer-readable Compact Disc, Digital Versatile Disc. The non-transitory recording medium 24 may be Universal Serial Bus (USB) memory, Solid State Drive or the like. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory recording medium 24.

In other words, the CPU 21 copies, on the memory 22, a software program (a computer program: hereinafter, referred to simply as a “program”) stored by the disk 23 when executing the program and executes arithmetic processing. The CPU 21 reads data necessary for program execution from the memory 22. When display is needed, the CPU 21 displays an output result on the display 28. When output is needed, the CPU 21 output an output result to the output device 26. When a program is input from the outside, the CPU 21 reads the program from the input device 25. The CPU 21 interprets and executes an inspection program (FIG. 2 or FIG. 4) present on the memory 22 corresponding to a function (processing) indicated by each unit illustrated in FIG. 1 or FIG. 3 described above. The CPU 21 sequentially executes the processing described in each example embodiment of the present invention.

In other words, in such a case, it is conceivable that the present invention can also be made using the inspection program. Further, it is conceivable that the present invention can also be made using a computer-readable, non-transitory recording medium storing the inspection program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2016-030696, filed on Feb. 22, 2016, the disclosure of which is incorporated herein in its entirety.

### REFERENCE SIGNS LIST

101 inspection device
102 vibration sensor unit
103 characteristic value calculation unit
104 scattering-degree calculation unit
105 determination unit
201 inspection device
121 external force information generation unit
125 determination unit
126 inspection device
20 calculation processing device
21 CPU
22 memory
23 disk
24 non-transitory recording medium
25 input device
26 output device
27 communication IF
28 display

What is claimed is:

1. An inspection device comprising:
a characteristic value calculator configured to calculate vibration characteristic values representing a character of vibration information indicating vibrations measured by vibration sensors measuring a vibration of an inspection target;
a scattering degree calculator configured to calculate a scattering degree indicating a scattering degree of the calculated vibration characteristic values among the vibrations measured by the vibration sensors; and
a determiner configured to determine a condition of the inspection target based on a magnitude of the calculated scattering degree.

2. The inspection device according to claim 1, wherein
the characteristic value calculator calculates the vibration characteristic values for vibration modes included in the measured vibrations, and
the determiner determines a damage of the inspection target based on a weighted average of scattering degrees for the vibration modes.

3. The inspection device according to claim 1 further comprising
a classifier configured to classify the vibration information in accordance with a magnitude of amplitude of the vibrations in the vibration information, wherein
the scattering degree calculator calculates the scattering degree for the classified vibration information.

4. The inspection device according to claim 1, wherein
the characteristic value calculator calculates a damping ratio for the vibration information or a resonant frequency for the vibration information as the vibration characteristic values.

5. The inspection device according to claim 3, wherein
the magnitude of the amplitude is maximum amplitude or substantially maximum amplitude in time-historical waveform of the vibration in the vibration information.

6. The inspection device according to claim 1, further comprising
the vibration sensors.

7. The inspection device according to claim 6, wherein
the vibration sensors measure vibrations at a plurality of positions of the inspection target.

8. The inspection device according to the claim 3 further comprising
a sensor for measuring a magnitude of exciting force to the inspection target, wherein
the characteristic value calculator calculates the vibration characteristic values representing a character of free vibration of the inspection target when the vibration sensors measure the free vibration occurred by the exciting force, and
the classifier classifies the vibration information based on the magnitude of the exiting force.

9. An inspection method comprising:
calculating vibration characteristic values representing a character of vibration information indicating vibrations measured by vibration sensors measuring a vibration of an inspection target;
calculating a scattering degree indicating a scattering degree of the calculated vibration characteristic values among the vibrations measured by the vibration sensors; and
determining a condition of the inspection target based on a magnitude of the calculated scattering degree.

10. A non-transitory recoding medium storing an inspection program recorded therein, the program making a computer achieve:
a characteristic value calculation function configured to calculate vibration characteristic values representing a character of vibration information indicating vibrations measured by vibration sensors measuring a vibration of an inspection target;
a scattering degree calculation function configured to calculate a scattering degree indicating a scattering degree of the calculated vibration characteristic values among the vibrations measured by the vibration sensors; and
a determination function configured to determine a condition of the inspection target based on a magnitude of the calculated scattering degree.
